(19) United States
(12) Patent Application Publication
(10) Pub. No.: US 2017/0331197 A1
(43) Pub. Date: Nov. 16, 2017

(54) INSET TYPE FEED ANTENNA STRUCTURE

(71) Applicant: CUBTEK INC., Hsinchu County (TW)

(72) Inventors: SHYH-JONG CHUNG, Hsinchu County (TW); HSIAO-NING WANG, Hsinchu County (TW)

(21) Appl. No.: 15/590,534

(22) Filed: May 9, 2017

(30) Foreign Application Priority Data
May 10, 2016 (TW) 105114398

(51) Int. Cl. H01Q 13/20; H01Q 9/28; H01Q 21/08; H01Q 21/06; H01Q 9/04; H01Q 9/06

(52) U.S. Cl. CPC H01Q 13/206; H01Q 9/0407; H01Q 9/065; H01Q 21/08; H01Q 21/065; H01Q 9/28

(57) ABSTRACT

An inset type feed antenna structure is disclosed includes a substrate, a patterned conductive layer disposed on an upper surface of the substrate, and a grounding layer disposed on a lower surface of the substrate. The patterned conductive layer includes a conductive line and a plurality of radiation units, wherein each radiation units includes a conductive patch provided with a notch on one side thereof, and a feeding line electrically connecting the conductive line and the notch, wherein the feeding line is a quarter-wave feeding line. The present invention not only decreases the distance between the radiation units and the conductive line to control the vertical side lobes, but also increases the impedance of each radiation unit, so that more radiation units can be fed in.

### BACKGROUND OF THE INVENTION

### 1. Field of the Invention

The present invention relates to antenna structures, and more particularly, to an inset type feed antenna structure applying a quarter-wave feeding structure.

### 2. Description of the Related Art

Conventionally, a microstrip antenna is formed in a plane structure, allowed to be produced in a great quantity, and able to be integrated onto active components are circuit boards. Therefore, microstrip antennas are massively applied on various portable electronic products, such as smartphones, tablets, laptops, GPS, and RFID field. For further enhancing the microstrip antenna gain in order to increase the transmitting distance of wireless signals, radiation units are usually disposed in an array arrangement and formed into an array antenna or application.

A conventional array antenna structure comprises a medium substrate, a grounding plate, plural radiation units, and at least a feed internet. The radiation unit is disposed above the medium substrate. The grounding plate is disposed below the medium substrate. The grounding plate is connected with the grounding of the RF circuit of the wireless communication product. Conventional array microstrip antennas are usually formed of components in an amount of 2N, such as a 1×2, 2×2, 2×4, or 4×4 structure. Also, such array antennas are usually excited by the feed internets disposed on edge of the microstrip wire. Since the basic property of the antenna structure is defined according to the positions of the feeding points, the design of the feed internet plays a critical role. However, convention solutions are relatively complicated. Therefore, it is desired to develop an antenna structure with simple structure and capable of enhancing the matching effect of the impedance.

### SUMMARY OF THE INVENTION

For improving the issues above, an inset type feed antenna structure is disclosed. By use of a quarter-wave feeding structure, distance between the radiation units is shortened, vertical side lobes are under controlled, and the impedance of each radiation unit is enlarged, such that more radiation units are allowed to be provided to be fed in.

For achieving the aforementioned objectives, an inset type feed antenna structure in accordance with an embodiment of the present invention is provided, comprising:
a substrate provided with an upper surface and a lower surface;
a patterned conductive layer disposed on the upper surface of the substrate, the patterned conductive layer further comprising:
   a conductive line; and
   plural radiation units disposed on two lateral sides of the conductive line, each radiation unit further comprising:
      a conductive patch provided with a notch disposed on one edge thereof; and
      a feeding line connecting the conductive line and the notch of the conductive patch, wherein the feeding line is a quarter-wave feeding line; and
a grounding layer disposed on the lower surface of the substrate.

### BRIEF DESCRIPTION OF THE DRAWINGS

FIG. 1 is a top view of the inset type feed antenna structure in accordance with an embodiment of the present invention.

FIG. 2 is a cross-sectional view taken along line A-A in FIG. 1.

FIG. 3 is a partially enlarged view of FIG. 1.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

An embodiment of an inset type feed antenna structure 1 is provided. By use of a quarter-wave feeding structure which fees each microstrip antenna structure, distance between the radiation units 124 and the conductive line 122 is shortened, vertical side lobes are under controlled, and the impedance of each radiation unit 124 is enlarged, such that more radiation units 124 are allowed to be provided to be fed in.

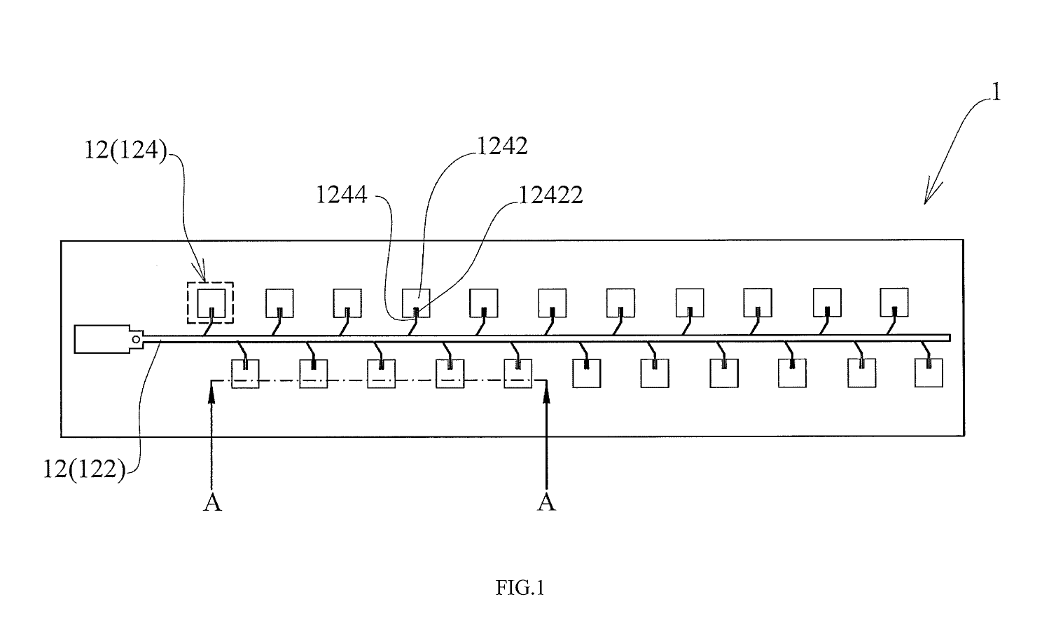

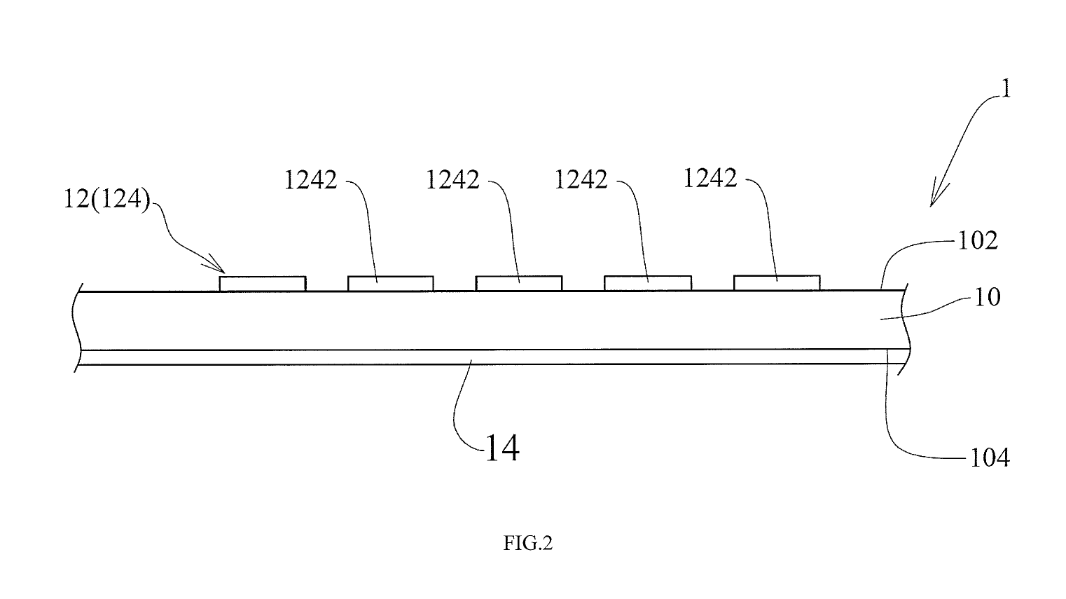

FIG. 1 is a top view of the inset type feed antenna structure 1 in accordance with an embodiment of the present invention; FIG. 2 is a cross-sectional view taken along line A-A in FIG. 1. As shown by the drawings, an embodiment of the inset type feed antenna structure 1 comprises a substrate 10 provided with an upper surface 102 and a lower surface 104, a patterned conductive layer 12 disposed on the upper surface 102 of the substrate 10, and a grounding layer 14 disposed on the lower surface 104 of the substrate 10. The patterned conductive layer 12 includes a conductive line 122 and plural radiation units 124, wherein the radiation units 124 are disposed on two lateral sides of the conductive line 122 and provided with a conductive patch 1242 and a feeding line 1244. The conductive patch 1242 includes a notch 12422 disposed on one edge of the conductive patch 1242. The feeding line 1244 connects the conductive line 122 and the notch 12422 of the conductive patch 1242, wherein the feeding line 1244 is a quarter-wave feeding line 1244. In an embodiment, the radiation units 124 are disposed on two lateral sides of the conductive line 122 in a strip shape array arrangement.

In the antenna array structure, each radiation unit 124 feeds each microstrip antenna through a section of a quarter-wave transmitting line in a manner of inset feeding. According to antenna related theory, the impedance of the edge portion of the microstrip antenna is at the maximum value, and the impedance gradually decreases toward the central point of the microstrip antenna. Therefore, when the antenna feeds from a portion in adjacent to the central point thereof, the impedance is controlled in a relatively small value. Then, through the quarter-wave transmitting line, the impedance increases to a higher value. Such configuration is able to effectively control the vertical side lobes.

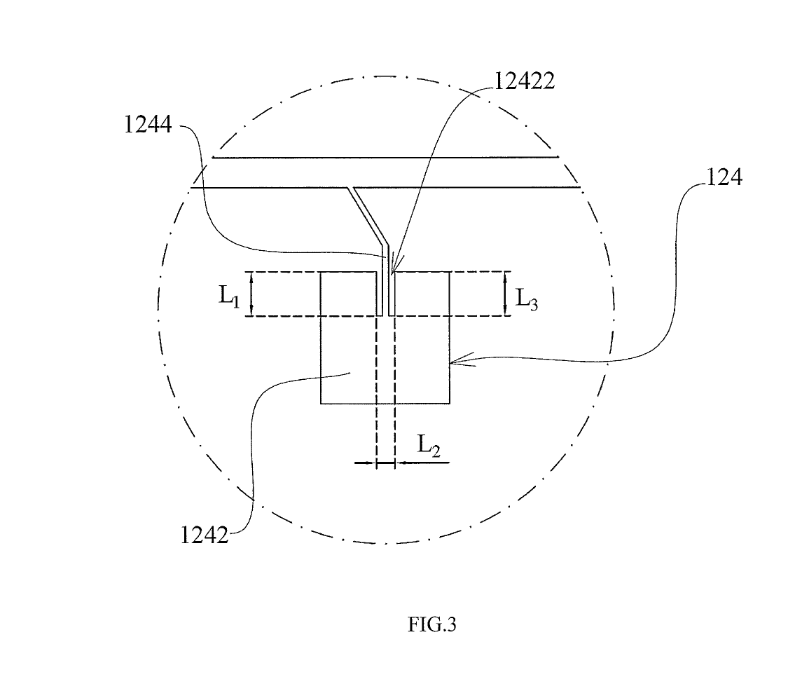

Accordingly, referring to FIG. 1 and FIG. 3, FIG. 3 is a partially enlarged view of FIG. 1, illustrating an enlarged structure of one of the radiation units 124. In an embodiment, the notch 12422 of the conductive patch 1242 is provided with a first section having a first length L₁, a second section having a second length L₂, and a third section having a third length L₃, wherein the first section and the third section are disposed in opposite to each other, and the feeding line 1244 is connected with the second section. Referring to FIG. 2, the first section and the third section are disposed in parallel, and the first length L₁ is identical to the third length 3. In the embodiment, the first length L₁ and the third length L₃ are larger than the second length L₂. The shape of the notch 12422 includes but is not limited to a rectangular. In an embodiment, a length of the sides of the conductive patch 1242 that are disposed in vertical to the conductive line 122 is defined as the length of the conductive patch 1242, and the length of the conductive patch 1242 is 3.3 mm; a length of the sides of the conductive patch 1242 that are disposed in parallel to the conductive line 122 is defined as the width of the conductive patch 1242, and the width of the conductive patch 1242 is 3.1 mm. Under such circumstances in this embodiment, the first length L₁ is 1.2 mm; the second length L₂ is 0.6 mm; the width of the feeding line 1244 is one-third of the second length L₂.

With the foregoing configuration, the inset type feed antenna structure 1 of the present invention applies the quarter-wave feeding structure to feed the recess-like structure of the conductive patch 1242 in a manner of inset feeding, the distance between of the radiation units 124 disposed in an array arrangement and the conductive line 122 is shortened by about 10%, such that the vertical side lobes thereof are effectively under controlled. Also, the impedance of each radiation unit 124 is enlarged, such that more radiation units 124 are allowed to be provided to be fed in.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An inset type feed antenna structure, comprising:
a substrate provided with an upper surface and a lower surface;
a patterned conductive layer disposed on the upper surface of the substrate, the patterned conductive layer further comprising:
a conductive line; and
plural radiation units disposed on two lateral sides of the conductive line, each radiation unit further comprising:
a conductive patch provided with a notch disposed on one edge thereof; and
a feeding line connecting the conductive line and the notch of the conductive patch, wherein the feeding line is a quarter-wave feeding line; and
a grounding layer disposed on the lower surface of the substrate.

2. The antenna structure of claim 1, wherein the radiation units are disposed on two sides of the conductive line in a strip shape array arrangement.

3. The antenna structure of claim 1, wherein the notch of the conductive patch is provided with a first section having a first length, a second section having a second length, and a third section having a third length, wherein the first section and the third section are disposed in opposite to each other, and the feeding line is connected with the second section.

4. The antenna structure of claim 3, wherein the first length is identical to the third length.

5. The antenna structure of claim 4, wherein the first section is disposed in parallel to the third section.

6. The antenna structure of claim 4, wherein the first length is larger than the second length.

7. The antenna structure of claim 3, wherein a length of the conductive patch is 3.3 mm, and the first length is 1.2 mm.

8. The antenna structure of claim 3, wherein a width of the conductive patch is 3.1 mm, and the second length is 0.6 mm.
